(19) United States
(12) Patent Application Publication
(10) Pub. No.: US 2020/0411844 A1
(43) Pub. Date: Dec. 31, 2020

(54) COMPOSITE ANODE AND LITHIUM SECONDARY BATTERY INCLUDING THE SAME

(71) Applicant: SAMSUNG SDI Co., Ltd., Yongin-si (KR)

(72) Inventors: Doori Oh, Yongin-si (KR); Yungu Cho, Yongin-si (KR); Heeyoung Chu, Yongin-si (KR); Hyun Soh, Yongin-si (KR); Yoonyoung Choi, Yongin-si (KR)

(21) Appl. No.: 16/913,760

(22) Filed: Jun. 26, 2020

(30) Foreign Application Priority Data
Jun. 26, 2019 (KR) 10-2019-0076345

(51) Int. Cl. H01M 4/133; H01M 4/38; H01M 4/134; H01M 4/36; H01M 10/0525

(52) U.S. Cl. CPC H01M 4/133; H01M 4/386; H01M 2004/021; H01M 4/366; H01M 10/0525; H01M 4/134

(57) ABSTRACT

A composite anode for a lithium secondary battery includes: a silicon-carbonaceous compound composite; a graphite; and a generally plate-shaped conductive material.

### CROSS REFERENCE TO RELATED APPLICATION

This application claims priority from and the benefit of Korean Patent Application No. 10-2019-0076345, filed on Jun. 26, 2019, which is hereby incorporated by reference for all purposes as if fully set forth herein.

### BACKGROUND

### Field

Exemplary implementations of the invention relate generally to a composite anode and, more specifically, to a lithium secondary battery including the same.

### Discussion of the Background

Lithium batteries are used as driving power sources in portable electronic devices such as video cameras, mobile phones, or notebook computers. Rechargeable lithium secondary is batteries have higher energy density per unit weight by three times or more and are charged at higher speeds than conventional lead-acid batteries, nickel-cadmium batteries, nickel-hydrogen batteries, or nickel-zinc batteries.

Lithium secondary batteries generate electric energy by oxidation and reduction reactions occurring when lithium ions are intercalated into/deintercalated from a cathode and an anode, each including an active material enabling intercalation and deintercalation of lithium ions, with an organic electrolytic solution or a polymer electrolytic solution filled between the cathode and the anode.

Recently, the need for batteries having high energy density suitable for large-sized electronic devices that require high output power such as electric vehicles has increased. Although attempts have been made to use silicon particles having high discharge capacity as an anode active material to realize batteries having high energy density, characteristics of an anode such as lifespan characteristics may deteriorate due to high volume changes of the silicon particles during charging and discharging.

To prevent volume expansion of silicon particles, attempts have been made to use a mixture of silicon particles and a carbonaceous material in a composite form. Particularly, a silicon-carbon composite includes graphite to provide conductivity to silicon particles and a carbon layer to suppress volume expansion as carbonaceous materials. However, as the amount of silicon particles increases, problems may arise in that stress and conductivity deteriorate due to volume changes thereof. In addition to deterioration of conductivity, problems may arise in that adhesion between silicon particles decreases due to volume expansion thereof via charging and discharging, and therefore there is still a need to solve the problems and develop a battery having a high energy density sufficient for large-sized electronic devices such as electric is vehicles.

The above information disclosed in this Background section is only for understanding of the background of the inventive concepts, and, therefore, it may contain information that does not constitute prior art.

### SUMMARY

Composite anodes and the lithium secondary batteries including the same constructed according to the principles and exemplary implementations of the invention provide excellent lifespan retention rates and high efficiency while exhibiting a certain level of conductivity. For example, by including a composite anode including a silicon-carbonaceous compound composite, graphite, and generally plate-shaped conductive material in predetermined compositions according the principles and exemplary implementations of the invention, significant and surprising improvement in cycle characteristics and conductivity of lithium secondary batteries are obtained

Additional features of the inventive concepts will be set forth in the description which follows, and in part will be apparent from the description, or may be learned by practice of the inventive concepts.

According to one aspect of the invention, a composite anode for a lithium secondary battery includes: a silicon-carbonaceous compound composite; a graphite; and a generally plate-shaped conductive material.

The silicon-carbonaceous compound composite may include silicon particles coated with a carbonaceous compound.

The silicon-carbonaceous compound composite may include a porous silicon is composite cluster having a porous core including a porous silicon composite secondary particle and a shell including a second graphene formed on the core.

The silicon-carbonaceous compound composite may include a silicon-containing composite including a porous silicon secondary particle; and a carbonaceous coating layer including a first amorphous carbon formed on the silicon-containing composite, wherein the silicon-containing composite may include a second amorphous carbon to adjust a density of the silicon-containing composite substantially identical to or lower than a density of the carbonaceous coating layer, the porous silicon secondary particle may include an aggregate of at least two silicon composite primary particles, the silicon composite primary particle may include: a silicon, a silicon suboxide of the formula of SiOₓ, where 0<x<2, on at least one surface of the silicon; and a first carbon flake on at least one surface of the silicon suboxide, and a second carbon flake is disposed on at least one surface of the porous silicon secondary particle.

The silicon-carbonaceous compound composite may include: a crystalline carbon; an amorphous carbon; and silicon nanoparticles having a generally acicular shape, a generally scaly shape, a generally plate-shape, or any combination thereof.

The composite anode may have a core-shell structure including: a core including the silicon-carbonaceous compound composite; and a shell including a carbon coating layer surrounding the surface of the core.

The graphite may include artificial graphite, natural graphite, or any mixture thereof.

The weight ratio of the silicon-carbonaceous compound composite to the graphite may be about 15:85 to about 20:80.

The amount of the generally plate-shaped conductive material may be about 5 is wt % to about 10 wt % based on a total weight of the composite anode.

The generally plate-shaped conductive material may have an average particle diameter (D₅₀) of about 3 μm to about 7 μm.

The generally plate-shaped conductive material may have a specific surface area of a BET value of about 13.5 m²/g to about 17.5 m²/g.

The generally plate-shaped conductive material may have a pellet density of about 1.7 g/cc to about 2.1 g/cc.

The generally plate-shaped conductive material may have a SFG6 graphite, a generally scaly graphite, a graphene, a graphene oxide, a carbon nanotube, or a mixture thereof.

The composite anode may have a silicon in an amount of about 5.5 wt % to about 9.5 wt % based on a total weight of the composite anode.

The silicon-carbonaceous compound composite, the graphite, and the generally plate-shaped conductive material may have a mixture density of about 1.5 g/cc or more.

The silicon-carbonaceous compound composite, the graphite, and the generally plate-shaped conductive material may have a composition ratio based on 100 parts by weight of the composite anode including: about 14.7 parts by weight to about 19.7 parts by weight of the silicon-carbonaceous compound composite; about 75.3 parts by weight to about 80.3 parts by weight of the graphite; and about 5 to about 10 parts by weight of the generally plate-shaped conductive material.

A lithium secondary battery may include: a cathode; the composite anode as described above; and an electrolyte.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the inventive concepts.

FIG. 1 is a graphical depiction illustrating electrode conductivity of exemplary embodiments of composite anodes prepared in Preparation Examples 1 to 3 according to principles of the invention and Comparative Preparation Examples 2 and 3.

FIG. 2 is a graphical depiction illustrating electrode conductivity of exemplary embodiments of composite anodes prepared in Preparation Examples 4 to 6 according to principles of the invention.

FIG. 3 is a graphical depiction illustrating cycle characteristics of exemplary embodiments of lithium secondary batteries prepared in Examples 1 to 3 according to principles of the invention and Comparative Examples 1 to 3.

FIG. 4 is a graphical depiction illustrating cycle characteristics of exemplary embodiments of lithium secondary batteries prepared in Examples 4 to 6 according to principles of the invention.

FIG. 5 is a schematic diagram illustrating an exemplary embodiment of a structure of a silicon-carbonaceous compound composite constructed according to principles of the invention.

FIG. 6 is a schematic diagram illustrating an exemplary embodiment of another structure of a silicon-carbonaceous compound composite constructed according to principles of the invention.

FIG. 7 is a perspective, cut-away diagram illustrating an exemplary embodiment of a structure of a lithium secondary battery constructed according to principles of the invention.

### DETAILED DESCRIPTION

In the following description, for the purposes of explanation, numerous specific details are set forth in order to provide a thorough understanding of various exemplary embodiments or implementations of the invention. As used herein “embodiments” and “implementations” are interchangeable words that are non-limiting examples of devices or methods employing one or more of the inventive concepts disclosed herein. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments. Further, various exemplary embodiments may be different, but do not have to be exclusive. For example, specific shapes, configurations, and characteristics of an exemplary embodiment may be used or implemented in another exemplary embodiment without departing from the inventive concepts.

Unless otherwise specified, the illustrated exemplary embodiments are to be understood as providing exemplary features of varying detail of some ways in which the inventive concepts may be implemented in practice. Therefore, unless otherwise specified, the features, components, modules, layers, films, panels, regions, and/or aspects, etc. (hereinafter individually or collectively referred to as “elements”), of the various embodiments may be otherwise combined, separated, interchanged, and/or rearranged without departing from the inventive concepts.

The use of cross-hatching and/or shading in the accompanying drawings is generally provided to clarify boundaries between adjacent elements. As such, neither the presence nor the absence of cross-hatching or shading conveys or indicates any preference or requirement for particular materials, material properties, dimensions, proportions, commonalities between illustrated elements, and/or any other characteristic, attribute, property, etc., of the elements, unless specified. Further, in the accompanying drawings, the size and relative sizes of elements may be exaggerated for clarity and/or descriptive purposes. When an exemplary embodiment may be implemented differently, a specific process order may be performed differently from the described order. For example, two consecutively described processes may be performed substantially at the same time or performed in an order opposite to the described order. Also, like reference numerals denote like elements.

When an element, such as a layer, is referred to as being “on,” “connected to,” or “coupled to” another element or layer, it may be directly on, connected to, or coupled to the other element or layer or intervening elements or layers may be present. When, however, an element, region, plate, or layer is referred to as being “directly on,” “directly connected to,” or “directly coupled to” another element or layer, there are no intervening elements, regions, plates, or layers present. To this end, the term “connected” may refer to physical, electrical, and/or fluid connection, with or without intervening elements. Further, the D1-axis, the D2-axis, and the D3-axis are not limited to three axes of a rectangular coordinate system, such as the x, y, and z-axes, and may be interpreted in a broader sense. For example, the D1-axis, the D2-axis, and the D3-axis may be perpendicular to one another, or may represent different directions that are not perpendicular to one another. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. As used herein, the term “and/or” includes any and all combinations of one or more of the associated listed items, and the “/” may be interpreted as either “and” or “or” depending on situations.

Although the terms “first,” “second,” etc. may be used herein to describe various types of elements, these elements should not be limited by these terms. These terms are used to distinguish one element from another element. Thus, a first element discussed below could be termed a second element without departing from the teachings of the disclosure.

Spatially relative terms, such as “beneath,” “below,” “under,” “lower,” “above,” “upper,” “over,” “higher,” “side” (e.g., as in “sidewall”), and the like, may be used herein for descriptive purposes, and, thereby, to describe one elements relationship to another element(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, numbers, integers, steps, operations, parts, elements, components, materials, combinations, and/or groups thereof, but do not preclude the presence or addition of one or more other features, numbers, integers, steps, operations, parts, elements, components, materials, combinations, and/or groups thereof. It is also noted that, as used herein, the terms “substantially,” “about,” and other similar terms, are used as terms of approximation and not as terms of degree, and, as such, are utilized to account for inherent deviations in measured, calculated, and/or provided values that would be recognized by one of ordinary skill in the art.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and should not be interpreted in an idealized or overly formal sense, unless expressly so defined herein.

As used herein, the term “composite” is not a state in which a plurality of elements having different properties are simply mixed in physical contact with each other, but rather, refers to a state in which elements are combined in a certain relationship via mechanochemical, electrochemical and/or chemical reactions which cannot be obtained via simple mixing. For example, the “composite anode” refers to an anode as a resultant obtained via the mechanochemical, electrochemical and/or chemical reactions.

A composite anode and a lithium secondary battery including the composite anode according to the exemplary embodiments of the invention will be described in more detail.

According to an exemplary embodiment, a composite anode includes: a silicon-carbonaceous compound composite; a graphite; and a generally plate-shaped conductive material. In this regard, the silicon-carbonaceous compound composite and the graphite may be anode active materials.

Here, the generally plate-shaped conductive material refers to a conductive material having a structural characteristic enabling surface contact between particles in the anode, resulting in improvement of conductivity and the degree of contact between particles in the anode. That is, the degree of contact between particles in the anode may be improved by the conductive material.

According to an exemplary embodiment, the silicon-carbonaceous compound composite may have a structure in which silicon particles are coated with the carbonaceous compound.

By forming the carbonaceous compound layer on the silicon particles, destruction and pulverization of particles occurring in conventional silicon particles may be prevented. The carbonaceous compound layer may serve as a clamping layer for preventing disintegration of the silicon particles. Because the carbonaceous compound layer may be maintained after repeating lithiation/delithiation cycles, the above-described clamping effect of the carbonaceous compound layer on preventing disintegration of silicon particles may be confirmed.

When the silicon particles swell, the carbonaceous compound layers may slide over one another. During a delithiation process, the carbonaceous compound layers may slide back to their relaxed positions. This movement may be caused because the van der Waals force is greater than a frictional force between the layers.

For example, the silicon-carbonaceous compound composite may have a structure in which graphite may be not included in the silicon particles, i.e., a structure in which a core of the composite does not include graphite.

As described above, the silicon-carbonaceous compound composite according to the exemplary embodiments has a structure in which the core does not include graphite, and thus a resistance of the composite may increase resulting in a decrease in conductivity. Thus, the exemplary embodiments provide a composite anode including a conductive material having a predetermined shape to improve conductivity and battery efficiency.

According to an exemplary embodiment, the silicon-carbonaceous compound composite may be a porous silicon composite cluster having a porous core including a porous silicon composite secondary particle and a shell including a second graphene formed on the core.

Particularly, the silicon-carbonaceous compound composite may include a silicon-containing composite including porous silicon secondary particles and a carbonaceous coating layer including a first amorphous carbon formed on the silicon-containing composite; the silicon-containing composite may include a second amorphous carbon to allow a density of the silicon-containing composite to be substantially identical to or lower than a density of the carbonaceous coating layer; the porous silicon secondary particle may include an aggregate of at least two silicon composite primary particles; the silicon composite primary particle may include silicon, a silicon suboxide (SiOₓ, where 0<x<2) on at least one surface of the silicon, and a first carbon flake on at least one surface of the silicon suboxide; and a second carbon flake may be formed on at least one surface of the porous silicon secondary particle.

The silicon suboxide may be present in a state of a film, a matrix, or any combination thereof, and the first carbon flake and the second carbon may be present in at least one state selected from a film, a particle, and a matrix, respectively.

The first carbon flake may be identical to the second carbon flake.

As used herein, the term “silicon suboxide” may have a single composition represented by SiOₓ (where 0<x<2). Alternatively, the silicon suboxide may refer to, for example, a combination including at least one selected from Si and SiO₂ with an average composition represented by SiOₓ (where 0<x<2). In addition, the silicon suboxide may be or include, for example SiO₂.

The “silicon suboxide” may be defined to include a silicon suboxide-like. The silicon suboxide-like refers to a substance having properties similar to those of the silicon suboxide with an average composition represented by SiOₓ (where 0<x<2) by including at least one selected from, for example, Si and SiO₂.

Densities of the silicon-containing composite and the carbonaceous coating layer may be evaluated by measuring porosities, or the like of the silicon-containing composite and the carbonaceous coating layer, respectively. The density of the silicon-containing composite may be equal to or less than that of the carbonaceous coating layer. The silicon-containing composite may have a porosity of about 60% or less, for example, about 30% to about 60% or a non-porous structure. Throughout the specification, the non-porous structure may refer to a structure having a porosity of about 10% or less, for example, about 5% or less, for example, about 0.01 to about 5%, or about 0%. The porosity is measured by Hg porosimetry.

The porosity may be in inversely proportional to the density. For example, it can be said that the porosity of the carbonaceous coating layer having a smaller porosity than that of the porous silicon composite cluster has a greater density.

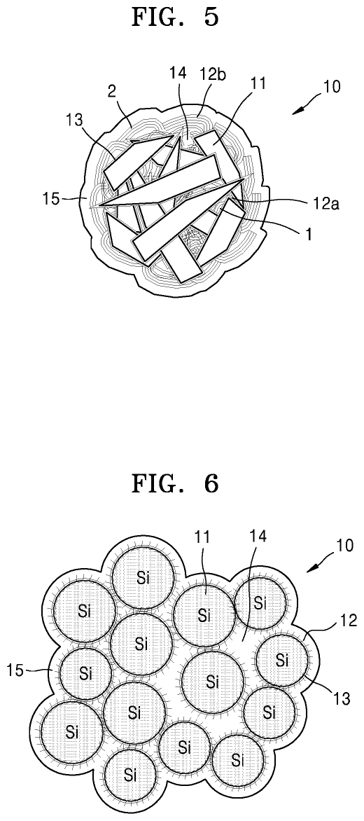

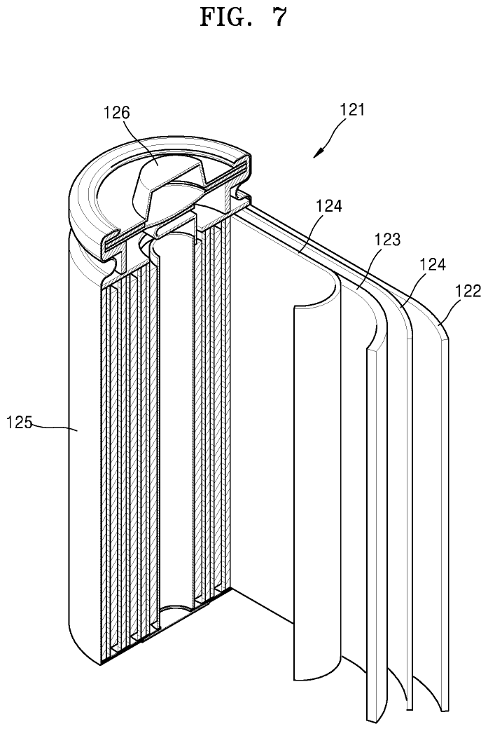

FIG. 5 is a schematic diagram illustrating an exemplary embodiment of a structure of a silicon-carbonaceous compound composite constructed according to principles of the invention. FIG. 5 shows a structure of a silicon-carbonaceous compound composite when silicon has a generally plate-shaped and/or an acicular shape. FIG. 6 is a schematic diagram illustrating an exemplary embodiment of another structure of a silicon-carbonaceous compound composite constructed according to principles of the invention. FIG. 6 shows a structure of a silicon-carbonaceous compound composite when silicon has a spherical particle shape and a first carbon flake is the same as a second carbon flake.

Referring to FIG. 5, a silicon-carbonaceous compound composite 10 may include a porous silicon secondary particle including an aggregate of at least two silicon composite primary particles. The silicon composite primary particle may include: silicon 11; a silicon suboxide 13 (SiOₓ, where 0<x<2) on at least one surface of the silicon 11; and a first carbon flake 12a on at least one surface of the silicon suboxide 13, and a second carbon flake 12b may be formed on at least one surface of the porous silicon secondary particle and a carbonaceous coating layer 15 including amorphous carbon may be formed on the second carbon flake 12b.

The first carbon flake 12a and the second carbon flake 12b (may be generically indicated as “12” in FIG. 6) may have a relatively low carbon density compared with the density of amorphous carbon of the carbonaceous coating layer 15. The carbon of the first carbon flake 12a and the second carbon flake 12b present on the surface of the silicon 11 may effectively buffer volume changes of the silicon 11, and the carbon of the carbonaceous coating layer 15 formed on an external surface of the cluster may improve physical stability of the cluster structure and may effectively inhibit a side reaction between the silicon 11 and an electrolyte during charging and discharging.

Here, the first carbon flake 12a and the second carbon flake 12b are substantially the same. The silicon-carbonaceous compound composite 10 may include the silicon-containing composite and the carbonaceous coating layer 15 including an amorphous carbon 14, and the inside or pores of the silicon-containing composite includes the amorphous carbon 14. The carbonaceous coating layer 15 may include a high-density amorphous carbon.

In the silicon-carbonaceous compound composite 10, the silicon 11 may have a generally spherical particle shape as shown in FIG. 6 different from that shown in FIG. 5. The silicon-containing composite of FIG. 6 corresponds to a case where both the first carbon flake 12a and the second carbon flake 12b of FIG. 5 are the same as a graphene flake 12, and the inside or pores of the silicon-containing composite may include an amorphous carbon 14.

The density of the silicon-containing composite may be substantially equal to or less than that of the carbonaceous coating layer 15 formed thereon. Here, the density may be evaluated by measuring porosity, or the like.

In FIGS. 5 and 6, the amorphous carbon 14 present inside the silicon-containing composite may be located between the silicon composite primary particles and/or the silicon composite secondary particles. The silicon composite primary particle may include: silicon 11; a silicon suboxide (SiOₓ, where 0<x<2) 13 on at least one surface of the silicon 11, and a first carbon flake 12a on at least one surface of the silicon suboxide 13.

The silicon-carbonaceous compound composites of FIGS. 5 and 6 may have a non-porous dense structure having pores filled with a dense amorphous carbon as described above. When the above-described structure is used in an anode active material of a lithium battery, side reactions with an electrolytic solution may be reduced and volume changes of silicon may be effectively buffered during charging and discharging, thereby reducing expansion ratio caused by physical volume expansion and maintaining mechanical characteristics of a cluster structure. Even when an electrolyte including an organic solvent such as fluoroethylene carbonate is used, battery performance such as lifespan characteristics and high-rate characteristics may be improved.

As used herein, the silicon suboxide refers to a silicon suboxide represented by SiOₓ (where 0<x<2). In the silicon composite primary particle, the silicon suboxide (SiOₓ, where 0<x<2) may be formed to cover at least one surface of the silicon. The first carbon flake of the silicon suboxide may be formed to cover at least one surface of the silicon suboxide.

The second carbon flake of the porous silicon secondary particle may be formed to cover at least one surface of the porous silicon secondary particle. The first carbon flake may be arranged directly on the silicon suboxide, and the second carbon flake may be arranged directly on the porous silicon secondary particle. Also, the first carbon flake may cover the surface of the silicon suboxide in whole or in part. For example, a coverage ratio of the silicon suboxide may be in the range of about 10% to about 100%, for example, about 10% to about 99%, for example, about 20% to about 95%, and for example about 40% to about 90% based on a total surface area of the silicon suboxide. The second carbon flake may grow directly from the surface of the silicon suboxide of the porous silicon secondary particle.

The first carbon flake may grow directly from the surface of the silicon suboxide to be located on the surface of the silicon suboxide. In addition, the second carbon flake may directly grow directly from the surface of the porous silicon secondary particle to be located directly on the surface of the porous silicon secondary particle.

In addition, the second carbon flake may cover the surface of the porous silicon secondary particle in whole or in part. For example, a coverage ratio of the second carbon flake may be in the range of about 5% to about 100%, for example, about 10% to about 99%, for example about 20% to about 95%, and for example, about 40% to about 90% based on a total surface area of the porous silicon secondary particle.

In the silicon-carbonaceous compound composite according to an exemplary embodiment, the silicon-containing composite may be present in the core of the composite and the second carbon flake may be included in the shell located on the core. When volume expansion of the silicon-carbonaceous compound composite occurs, silicon easily contact carbon because carbon may be present in the form of flakes in the shell. The core of the composite may include pores which serve as a buffer space when the composite expands, and the shell may include the carbonaceous coating layer including a high-density amorphous carbon, thereby inhibiting permeation of the electrolyte. The shell may prevent the core of the composite from being physically pressed. In addition, the carbonaceous coating layer including the amorphous carbon as described above may facilitate migration of lithium during charging and discharging. The carbonaceous coating layer may cover the surface area of the silicon-containing composite in whole or in part. The coverage ratio of the carbonaceous coating layer may be, for example, in the range of about 5% to about 100%, for example, about 10% to about 99%, for example, about 20% to about 95%, and for example, about 40% to about 90% based on a total surface area of the silicon-containing composite.

The silicon-carbonaceous compound composite according to an exemplary embodiment may have a non-spherical shape and may have a circularity of, for example, about 0.9 or less, for example, about 0.7 to about 0.9, for example, about 0.8 to about 0.9, and for example, about 0.85 to about 0.9.

As used herein, the circularity is determined using Equation 1 below, where A is an area and P is a perimeter.

$$circularity = \frac{4 π A}{{P}^{2}} \qquad Equation 1$$

The first carbon flake and the second carbon flake may include any carbonaceous material having a flake or flake-like shape. Examples of the carbonaceous material may include graphene, graphite, carbon fiber, graphitic carbon, or graphene oxide.

The silicon-carbonaceous compound composite according to an exemplary embodiment may include a first graphene and a second graphene instead of the first carbon flake and the second carbon flake, respectively. In this regard, the first graphene and the second graphene may have a structure of a nanosheet, a layer (or film), a graphene nanosheet, a flake, or the like. The term “nanosheet” refers to a structure non-uniformly formed on the silicon suboxide or the porous silicon secondary particle to a thickness of about 1000 nm or less, for example, about 1 nm to about 1,000 nm, and the term “layer” refers to a continuous and uniform film formed on the silicon suboxide or the porous silicon secondary particle.

In the carbonaceous coating layer, the amorphous carbon may include at least one selected from pitch carbon, soft carbon, hard carbon, meso-phase pitch carbide, sintered coke, and carbon fiber.

The carbonaceous coating layer may further include crystalline carbon. By further including crystalline carbon, the carbonaceous coating layer may efficiently perform buffering action against volume expansion of the silicon-containing composite.

The crystalline carbon may include at least one selected from natural graphite, artificial graphite, graphene, fullerene, and carbon nanotube. In the silicon-carbonaceous compound composite, the mixing ratio of total carbon of the first carbon flake and the second carbon flake (first carbon) to carbon of the carbonaceous coating layer (second carbon) may be in the range of about 30:1 to about 1:3 by weight, for example, about 20:1 to about 1:1 by weight, particularly, about 10:1 to about 1:0.9 by weight. The first carbon refers to the total of the first carbon flake and the second carbon flake. When the mixing ratio of the first carbon to the second carbon is within the ranges above, lithium batteries having excellent discharge capacities with improved capacity retention rates may be manufactured.

The mixing ratio of the first carbon to the second carbon described above may be identified by thermogravimetric analysis (TGA). The first carbon is related to peaks appearing at about 700° C. to about 750° C., and the second carbon is related to peaks appearing at about 600° C. to about 650° C.

The TGA may be performed, for example, at a temperature of about 25° C. to about 1,000° C. under atmospheric conditions with a temperature increase rate of about 10° C./min.

According to an exemplary embodiment, the first carbon may be crystalline carbon and the second carbon may be amorphous carbon. The mixing ratio of a total weight of the first carbon flake and the second carbon flake to a total weight of the first amorphous carbon and the second amorphous carbon may be in the range of about 1:99 to about 99:1, for example, about 1:20 to about 80:1, and for example, about 1:1 to about 1:10.

As used herein, the term “cluster” refers to an aggregate of two or more primary particles, and may be construed as having substantially the same meaning as “secondary particle”.

As used herein, the term “graphene” may have a structure in the form of flakes, nanosheets, or layers (or films). Here, the nanosheets refers to a structure non-uniformly formed on the silicon suboxide or the porous silicon secondary particle and the layer refers to a continuous and uniform film formed on the silicon suboxide or the porous silicon secondary particle. As such, the graphene may have a structure including distinct layers or a structure without any distinct layers.

In the silicon-containing composite according to an exemplary embodiment, the porous silicon secondary particle may have a particle size of about 1 μm to about 20 for example, about 2 μm to about 18 and for example, about 3 μm to about 10 and the carbon flakes may have a size of about 1 nm to about 200 nm, for example, about 5 nm to about 150 nm, and for example, about 10 nm to about 100 nm. Herein, the size refers either to the diameter or a dimension of a major axis.

The diameter ratio of the porous silicon secondary particle to the silicon-containing composite may be in the range of about 1:1 to about 1:30, for example, about 1:2 to about 1:30, for example, about 1:5 to about 1:25, particularly, about 1:21. The diameter ratio of the porous silicon secondary particle to the porous silicon composite cluster refers to a size ratio of the porous silicon secondary particle and the silicon-containing composite when both have a spherical shape. When the porous silicon secondary particle and the silicon-containing composite are non-spherical shapes, the diameter ratio may be a ratio of the major axes thereof.

According to another exemplary embodiment, the diameter of the porous silicon secondary particle of the silicon-containing composite may be about 1 μm to about 20 μm, for example, about 2 μm to about 15 μm, and for example, about 3 μm to about 10 μm. The thickness of shell of the silicon-containing composite may be about 10 nm to about 5,000 nm (about 0.1 μm to about 5 μm), for example, about 10 nm to about 1,000 nm, and for example, about 10 nm to about 500 nm. The ratio of the diameter of the core including the silicon-containing composite to the thickness of the carbon coating layer of the shell may be about 1:0.001 to about 1:1.67, for example, about 1:0.01, 1:1.67, 1:0.0033, or 1:0.5.

In the silicon-containing composite, the total amount of the first carbon flake and the second carbon flake may be in the range of about 0.1 parts by weight to about 2,000 parts by weight, for example, about 0.1 parts by weight to about 300 parts by weight, for example, about 0.1 parts by weight to about 90 parts by weight, particularly, about 5 parts by weight to about 30 parts by weight based on 100 parts by weight of silicon. When the total amount of the first carbon flake and the second carbon flake is within the ranges above, volume expansion of the silicon may be effectively suppressed and conductivity may be improved.

The first carbon flake and the second carbon flake may be, for example, graphene flakes. In a silicon-carbonaceous compound composite according to an exemplary embodiment the first carbon flake may be a graphene flake in the silicon composite primary particle, the graphene flake may be spaced apart from a silicon suboxide (SiOₓ, where 0<x<2) by a distance of about 10 nm or less, for example, about 5 nm or less, for example, about 3 nm or less, and for example, the distance of about 1 nm or less, a total thickness of the graphene flake is in the range of about 0.3 nm to about 1,000 nm, for example, about 0.3 nm to about 50 nm, for example, about 0.6 nm to about 50 nm, and for example, about 1 nm to about 30 nm, and the graphene flake is oriented at an angle of about 0° to about 90°, for example, about 10° to about 80°, and for example, about 20° to about 70° with a major axis (e.g., Y axis) of the silicon. As used herein, the major axis refers to Y axis. The graphene flake of the silicon composite primary particle is also referred to as second graphene flake.

In the porous silicon secondary particle according to an exemplary embodiment, the second carbon flake may be a graphene flake, and the graphene flake may be spaced apart from a silicon suboxide (SiOₓ, where 0<x<2) by the distance of about 1,000 nm or less, for example, about 500 nm or less, for example, about 10 nm or less, for example, about 1 nm or less, for example, about 0.00001 nm to about 1 nm, for example, about 0.00001 nm to about 0.1 nm, and for example, about 0.00001 nm to about 0.01 nm, a total thickness of the graphene flake is in the range of about 0.3 nm to about 50 nm, and for example, about 1 nm to about 50 nm, and the graphene flake is oriented at an angle of about 0° to about 90°, and for example, about 10° to about 80°, and for example, about 20° to about 70° with a major axis (e.g., Y axis) of the silicon.

The major axis of silicon may refer to a major axis of the porous silicon secondary particle. The graphene flake of the porous silicon secondary particle is referred to as first graphene flake.

The graphene flake may have, for example, at least one graphene layer, for example, about 1 to about 50 graphene layers, for example, about 1 to about 40 graphene layers, for example, about 1 to about 30 graphene layers, and for example, about 1 to about 20 graphene layers.

The silicon suboxide (SiOₓ, where 0<x<2) formed on the surface of silicon may have a thickness of about 30 μm or less, for example, about 10 μm or less, for example, about 1 μm or less, for example, about 1 nm to about 100 nm, for example, about 1 nm to about 50 nm, for example, about 1 nm to about 20 nm, and for example, about 10 nm. The silicon suboxide may cover the surface of silicon in whole or in part. The coverage ratio of the silicon suboxide may be, for example, about 100%, for example, about 10% to about 100%, for example about 10% to about 99%, for example about 20% to about 95%, and for example about 40% to about 90%, based on the entire surface area of silicon.

The shape of silicon is not particularly limited and the silicon may be in the form of, for example, spherical particles, nanowires, acicular particles, rods, particles, nanotubes, nanorods, wafer, nanoribbons, or any combination thereof. The average size of silicon may be in the range of about 10 nm to about 30 for example, about 10 nm to about 1,000 nm, for example, about 20 nm to about 150 nm, and for example, about 100 nm. The average size of silicon may refer to an average particle diameter when silicon is in the shape of generally spherical particles. When silicon is in the shape of non-spherical particles, e.g., generally plate-shaped particles or generally acicular particles, the average size may refer to a dimension of a major axis, a length, or a thickness.

The porous silicon secondary particle may have an average particle diameter (D₅₀ particle diameter) of about 200 nm to about 50 for example, about 1 μm to about 30 for example, about 2 μm to about 25 for example, about 3 μm to about 20 for example, about 1 μm to about 15 particularly for example, about 3 μm to about 8 μm or about 7 μm to about 11 The porous silicon secondary particle may have a D₁₀ particle diameter of about 0.001 μm to about 10 for example, about 0.005 μm to about 5 and for example about 0.01 μm to about 1 In addition, the porous silicon secondary particle may have a D₉₀ particle diameter of about 10 μm to about 60 for example, about 12 μm to about 28 and for example, about 14 μm to about 26 μm.

As used herein, the D₅₀ particle diameter refers to a particle diameter corresponding to 50% of the particles in a cumulative distribution curve in which particles are accumulated in the order of particle diameter from the smallest particle to the largest particle and a total number of accumulated particles is 100%. Similarly, the terms “D₁₀” and “D₉₀^{”} respectively indicate particle diameters corresponding to 10% and 90% of the particles in the cumulative distribution curve of the porous silicon secondary particle, respectively.

The porous silicon secondary particle may have a specific surface area of about 0.1 m²/g to about 100 m²/g, for example, about 1 m²/g to about 30 m²/g, and for example, about 1 m²/g to about 5 m²/g. In addition, the porous silicon secondary particle has a density of about 0.1 g/cc to about 2.8 g/cc, for example, about 0.1 g/cc to about 2.57 g/cc, and for example, about 0.5 g/cc to about 2 g/cc.

When the carbonaceous coating layer is formed on the surface of the silicon-carbonaceous compound composite, lithium batteries having improved lifespan characteristics may be manufactured.

A ratio of the diameter of the silicon-containing composite to a thickness of the carbonaceous coating layer may be in the range of about 1:1 to about 1:50, for example, about 1:1 to about 1:40, and particularly, about 1:0.0001 to about 1:1.

The carbonaceous coating layer may have a thickness of about 1 nm to about 5,000 nm, for example about 10 nm to about 2,000 nm, and for example about 5 nm to about 2,500 nm.

The carbonaceous coating layer may have a single-layered structure including amorphous carbon and crystalline carbon. The carbonaceous coating layer may have a double-layered structure having a first carbonaceous coating layer including amorphous carbon and a second carbonaceous coating layer including crystalline carbon.

In the double-layered structure, the first carbonaceous coating layer including amorphous carbon and the second carbonaceous coating layer including crystalline carbon may be sequentially stacked on the silicon-containing composite or the second carbonaceous coating layer including crystalline carbon and the first carbonaceous coating layer including amorphous carbon may be sequentially stacked on the silicon-containing composite.

The silicon-carbonaceous compound composite has a narrow particle size distribution. For example, the porous silicon cluster (secondary particle) may have an average particle diameter (D₅₀ particle diameter) of about 1 μm to about 30 μm, a D₁₀ particle diameter of about 0.001 μm to about 10 and a D₉₀ particle diameter of about 10 μm to about 60 As described above, the silicon-containing composite according to an exemplary embodiment may have a narrow particle size distribution, unlike conventional silicon secondary particles obtained from silicon composite primary particles, which may have a broader and irregular secondary particle size distribution that make difficult to control the particle size of an anode active material to improve the cell performance.

Graphene may serve to inhibit destruction and pulverization of particles that occur in conventional silicon particles. A graphene sliding layer may serve as a clamping layer that inhibits disintegration of silicon particles. In addition, an alloying reaction between lithium ions and silicon (Si) may occur, thereby improving the specific capacity and providing a continuous conductive path between particles.

The graphene layers may slide over one another when the silicon particles swell and slide back to their relaxed positions during a delithiation process. Such movement may be caused because the van der Waals force is greater than a frictional force between the layers.

The clamping effect of the above-described graphene layers on preventing disintegration of the silicon particles may be confirmed by evaluating whether the graphene layers remain as they are, even after repeated lithiation/delithiation cycles.

The silicon-containing composite according to an exemplary embodiment may have excellent capacity characteristics with a capacity of about 600 mAh/cc to about 2,000 mAh/cc.

According to another exemplary embodiment, a silicon-carbonaceous compound composite may include a silicon-containing composite including porous silicon secondary particles and a carbonaceous coating layer including a first amorphous carbon formed on the silicon-containing composite.

The silicon-containing composite may include a second amorphous carbon allowing a density of the silicon-containing composite to be identical to or lower than a density of the carbonaceous coating layer.

The silicon composite secondary particle may include an aggregate of at least two silicon composite primary particles.

The silicon composite primary particle may include a silicon suboxide selected from i) a silicon suboxide (SiOₓ, where 0<x<2) and ii) a heat-treated product of a silicon suboxide (SiOₓ, where 0<x<2), and a first carbon flake on at least one surface of the silicon suboxide.

A second carbon flake may be formed on at least one surface of the porous silicon secondary particle. The silicon suboxide may be present in the form of a film, a matrix, or any combination thereof, and the first carbon flake and the second carbon may be present in at least one form selected from a film, a particle, and a matrix, respectively.

According to another exemplary embodiment, a silicon-carbonaceous compound composite may have substantially the same structure as the above-described silicon-carbonaceous compound composite, except that the carbonaceous coating layer including the first amorphous carbon formed on the silicon-containing composite is not included.

As used herein, the term “heat-treated product of a silicon suboxide (SiOₓ, where 0<x<2)” refers to a product obtained by heat-treating SiOₓ (where 0<x<2). In this regard, the heat treatment may refer heat treatment for a vapor deposition reaction to grow graphene flakes on SiOₓ (where 0<x<2). During the vapor deposition reaction, a carbon source gas or a gas mixture including a carbon source gas and a reducing gas may be used as a graphene flake source. The reducing gas may be, for example, hydrogen.

The heat-treated product of SiOₓ (where 0<x<2) may be a product obtained by heat-treating SiOₓ (where 0<x<2) in an atmosphere including i) a carbon source gas or ii) a gas mixture including a carbon source gas and a reducing gas.

The heat-treated product of the silicon suboxide (SiOₓ, where 0<x<2) may be a structure in which silicon (Si) is located on a matrix of a silicon suboxide (SiO_{y}, where 0<y<2). The heat-treated product of the silicon suboxide (SiOₓ, where 0<x<2) according to an exemplary embodiment may be, for example, i) a structure in which Si is located in a silicon suboxide (SiO₂) matrix, ii) a structure in which Si is located in a matrix including SiO₂ and SiO_{y} (where 0<y<2), or iii) a structure in which Si is located in a SiO_{y} (where 0<y<2) matrix. In other words, the heat-treated product of the silicon suboxide includes Si in a matrix including SiO₂, SiO_{y} (where 0<y<2), or any combination thereof.

For example, the silicon-carbonaceous compound composite may have a structure in which graphite is included in silicon particles. For example, the silicon-carbonaceous compound composite may have a structure in which graphite is included in a core of a composite.

For example, the silicon-carbonaceous compound composite may include: crystalline carbon; amorphous carbon; and silicon nanoparticles having a generally acicular shape, a generally scaly shape, a generally plate-shaped, or any combination thereof.

For example, the silicon-carbonaceous compound composite may have a structure in which the silicon nanoparticles are located and/or in the crystalline carbon.

In this regard, the silicon nanoparticles may have an average particle diameter of about 5 nm to about 150 nm and an aspect ratio of about 4 to about 10. When the silicon nanoparticles has a generally acicular shape, a generally scaly shape, or a generally plate-shaped and an aspect ratio of about 4 to about 10, electrode expansion ratios may be reduced during the manufacture of anodes, resulting in improvement of lifespans of batteries.

In this regard, the “aspect ratio” refers to a ratio of the longest linear dimension among cross-sections of silicon nanoparticles to the shortest linear dimension among the cross-sections of the silicon nanoparticles. The longest linear dimension among the cross-sections of the silicon nanoparticles is referred to as “longer diameter” and the shortest linear dimension among the cross-sections of the silicon nanoparticles is referred to as “shorter diameter”.

The average particle diameter of the silicon nanoparticles may be in the range of about 5 nm to about 150 nm, for example, about 10 nm to about 150 nm, particularly, about 30 nm to about 150 nm, more particularly, about 50 nm to about 150 nm, and narrowly, about 60 nm to about 100 nm, and more narrowly about 80 nm to about 100 nm. The average particle diameter, which is measured by adding silicon nanoparticles to a particle size analyzer, refers to a particle diameter at 50 vol % (D50) of a cumulative volume in a cumulative size-distribution curve.

More particularly, the silicon nanoparticles may have a longer diameter of about 50 nm to about 150 nm and a shorter diameter of about 5 nm to about 37 nm. When the silicon nanoparticles have the particle size within the ranges above, electrode expansion ratios may be reduced during the manufacture of anodes, resulting in increases in lifespans of batteries.

There is a correlation between the average particle diameter of silicon nanoparticles and the aspect ratio of the silicon nanoparticles. Particularly, as the average particle diameter of the silicon nanoparticles decreases by about 1%, the aspect ratio of the silicon nanoparticles may increase by about 3% to about 5%. For example, when the average particle diameter of the silicon nanoparticles decreases by about 1%, the aspect ratio of the silicon nanoparticles may increase by about 4%. Therefore, when the average particle diameter of the silicon nanoparticles decreases, silicon nanoparticles having a relatively high aspect ratio may be provided.

The silicon nanoparticles may include one or more crystal grains. For example, the silicon nanoparticles according to an exemplary embodiment may be single crystalline silicon nanoparticles each formed of one crystal grain or polycrystalline silicon nanoparticles each including a plurality of crystal grains. In addition, the silicon nanoparticles are not necessarily crystalline and may have a partial crystalline structure and a partial amorphous structure.

In this regard, the one or more crystal grains included in the silicon nanoparticles may have an average particle diameter of about 5 nm to about 20 nm, particularly, about 10 nm to about 20 nm, more particularly, about 15 nm to about 20 nm. When the crystal grains of the silicon nanoparticles have an average particle diameter within the ranges above, the electrode expansion ratios may further be reduced during the manufacture of anodes.

The crystalline carbon according to an exemplary embodiment may have a generally scaly shape or a generally plate-shape and may be artificial graphite, natural graphite, or any combination thereof. The crystalline carbon may have an average particle diameter of about 5 μm to about 10 When the crystalline carbon has a generally scaly shape or a generally plate-shape similar to those of the silicon nanoparticles, the crystalline carbon may be more uniformly distributed with the silicon nanoparticles, and thus diffusion paths of lithium ions may be reduced due to uniform distribution of particles having similar shapes, resulting in improvement of high-rate characteristics and output characteristics of batteries.

The amorphous carbon may be soft carbon or hard carbon, meso-phase pitch carbide, sintered coke, and the like. As described above, the silicon-carbonaceous compound composite may have the shape of an aggregate in which the above-described silicon nanoparticles and crystalline carbon particles are combined by the amorphous carbon.

According to an exemplary embodiment, when the total weight of the silicon-carbonaceous compound composite is regarded as 100 wt %, the amount of the silicon nanoparticles may be in the range of about 35 wt % to about 45 wt %, the amount of the crystalline carbon may be in the range of about 35 wt % to about 45 wt %, and the amount of the amorphous carbon may be in the range of about 10 wt % to about 30 wt % based on the total weight of the silicon-carbonaceous compound composite.

When the silicon nanoparticles, the crystalline carbon, and the amorphous carbon are included within the amount ranges described above, electrode expansion ratios may be reduced and battery lifespans may be improved without decreasing capacities of manufactured anodes.

The anode active material may have a core-shell structure. The anode active material having the core-shell structure may include a core located at the center and a shell surrounding the surface of the core.

The core located at the center of the anode active material may be the above-described silicon-carbonaceous compound composite formed of the silicon nanoparticles, the crystalline carbon, and the amorphous carbon.

The shell includes a carbon coating layer surrounding the surface of the core. The carbon coating layer may be a crystalline carbon coating layer or an amorphous carbon coating layer. The crystalline carbon coating layer may be formed by mixing inorganic particles with crystalline carbon in a solid phase or a liquid phase and heat-treating the mixture. The amorphous carbon coating layer may be formed by coating an amorphous carbon precursor on the surface of the inorganic particles and then carbonizing the coating by heat treatment.

In this regard, the carbon coating layer may have a thickness of about 1 nm to about 100 nm, for example, about 5 nm to about 100 nm. By the carbon coating layer having the thickness within the ranges above, expansion of the silicon nanoparticles may be inhibited without obstructing intercalation and deintercalation of lithium ions, thereby maintaining battery performance.

According to an exemplary embodiment, in the anode active material for lithium secondary batteries having the core-shell structure, the amount of the crystalline carbon may be in the range of about 30 wt % to about 50 wt % based on the total weight of the carbon coating layer and the silicon-carbonaceous compound composite, the amount of the amorphous carbon may be in the range of about 10 wt % to about 40 wt % based on the total weight of the carbon coating layer and the silicon-carbonaceous compound composite, and the amount of the silicon nanoparticles may be in the range of about 20 wt % to about 60 wt % based on the total weight of the carbon coating layer and the silicon-carbonaceous compound composite. According to an exemplary embodiment, the graphite may be artificial graphite, natural graphite, or any mixture thereof. For example, the graphite may be artificial graphite.

The composite anode according to exemplary embodiments further includes graphite in addition to the above-described silicon-carbonaceous compound composite, and thus high-rate characteristics of the composite anode are improved, thereby improving input and output characteristics of batteries including the composite anode.

According to an exemplary embodiment, the weight ratio of the silicon-carbonaceous compound composite to the graphite may be from about 15:85 to about 20:80. For example, the weight ratio of the silicon-carbonaceous compound composite to the graphite may be from about 15:85 to about 18:82. For example, the weight ratio of the silicon-carbonaceous compound composite to the graphite may be from about 15.5:84.5 to about 16:84. When the weight ratio of the silicon-carbonaceous compound composite and the graphite is out of the above ranges, e.g., greater than about 16.3:83.7, capacity may exceed a target level and lifespan characteristic may deteriorate. On the contrary, when the weight ratio is less than about 15.5:84.5, capacity characteristics of an anode may deteriorate.

The composite anode according to exemplary embodiments includes the generally plate-shaped conductive material as described above. The generally plate-shaped conductive material has a higher degree of contact between particles in an anode mixture and more efficiently buffers volume change during charging and discharging than a generally spherical conductive material.

According to an exemplary embodiment, the amount of the generally plate-shaped conductive material may be about 5 wt % or more based on a total weight of the composite anode. When the amount of the generally plate-shaped conductive material is out of the above range, e.g., less than about 5 wt % based on the total weight of the composite anode, it is difficult to sufficiently improve conductivity. For example, the amount of the generally plate-shaped conductive material may be in the range of about 5 wt % to about 10 wt % based on the total weight of the composite anode. When the amount of the generally plate-shaped conductive material is out of the above range, e.g., greater than about 10 wt % based on the total weight of the composite anode, initial efficiency of a battery may decrease and adhesion between a current collector and the anode mixture may decrease.

According to an exemplary embodiment, the generally plate-shaped conductive material may have an average particle diameter (D₅₀ particle diameter) of about 3 μm to about 7 μm. The average particle diameter (D₅₀) refers to a particle diameter corresponding to 50% of particles in a particle diameter distribution.

When the average particle diameter (D₅₀ particle diameter) of the generally plate-shaped conductive material is out of the above range, e.g., less than about 3 μm, a specific surface area increases, thereby causing a side reaction. On the contrary, when the average particle diameter (D₅₀ particle diameter) of the generally plate-shaped conductive material is greater than about 7 μm, conductivity decreases resulting in deterioration of rate characteristics and a decrease in obtainable capacity. According to an exemplary embodiment, the generally plate-shaped conductive material may have a specific surface area (Brunauer, Emmett and Teller (hereinafter “BET”) value) of about 13.5 m²/g to about 17.5 m²/g.

According to an exemplary embodiment, the generally plate-shaped conductive material may have a pellet density of about 1.7 g/cc to about 2.1 g/cc. When the above-described physical properties of the generally plate-shaped conductive material are satisfied, excellent conductivity may be obtained and a decrease in battery efficiency may be minimized. Thus, problems of conventional silicon-carbon composites such as deterioration of conductivity and lifespan characteristics caused by increasing the amount of silicon are solved.

According to an exemplary embodiment, the generally plate-shaped conductive material may be selected from a graphite sold under the trade designation TIMREX® having a grade of SFG6 from Imerys Graphite and Carbon of Bodio, Switzerland (hereinafter “SFG6 graphite”), a generally scaly graphite, graphene, graphene oxide, carbon nanotube (CNT), and any mixture thereof.

According to an exemplary embodiment, the composite anode may include silicon in the amount of about 5.5 wt % to about 9.5 wt % based on the total weight of the composite anode.

According to an exemplary embodiment, the silicon-carbonaceous compound composite, the graphite, and the generally plate-shaped conductive material may have a mixture density of about 1.5 g/cc or more. For example, the silicon-carbonaceous compound composite, the graphite, and the generally plate-shaped conductive material may have a mixture density of about 1.5 g/cc to about 1.75 g/cc.

The composite anode may include the silicon-carbonaceous compound composite, the graphite, and the generally plate-shaped conductive material in a composition ratio described below based on 100 parts by weight of the total weight of the composite anode:

silicon-carbonaceous compound composite—about 14.7 parts by weight to about 19.7 parts by weight;

graphite—about 75.3 parts by weight to about 80.3 parts by weight; and

generally plate-shaped conductive material—about 5 parts by weight to about 10 parts by weight.

According to another exemplary embodiment, a lithium secondary battery includes: a cathode; the above-described composite anode; and an electrolyte.

The lithium secondary battery may be manufactured according to the following method.

First, the above-described composite anode is prepared. The composite anode may include a binder between an anode current collector and an anode active material layer or inside the anode active material layer. The binder will be described in detail.

The composite anode and the lithium secondary battery including the same may be manufactured according to the following method. The composite anode includes the silicon-carbonaceous compound composite, the graphite, and the generally plate-shaped conductive material described above and may be manufactured, for example, by preparing an anode active material composition by mixing the silicon-carbonaceous compound composite, the graphite, and the generally plate-shaped conductive material in a solvent, and molding the composition in a predetermined shape or coating the composition on a current collector such as a copper foil.

The binder used in the anode active material composition assists binding of the anode active material to the conductive material and to the current collector. The binder may be included between the anode current collector and the anode active material layer or inside the anode active material layer in the amount of about 1 part by weight to about 50 parts by weight based on 100 parts by weight of the anode active material. For example, the amount of the binder may be in the range of about 1 part by weight to about 30 parts by weight, about 1 part by weight to about 20 parts by weight, or about 1 part by weight to about 15 parts by weight based on 100 parts by weight of the anode active material.

Examples of the binder may include a polyvinylidenefluoride, a polyvinylidenechloride, a polybenzimidazole, a polyimide, a polyvinylacetate, a polyacrylonitrile, a polyvinyl alcohol, a carboxymethylcellulose (CMC), a starch, a hydroxypropylcellulose, a regenerated cellulose, a polyvinylpyrrolidone, a tetrafluoroethylene, a polyethylene, a polypropylene, a polystyrene, a polymethylmethacrylate, a polyaniline, an acrylonitrilebutadienestyrene, a phenol resin, an epoxy resin, a polyethyleneterephthalate, a polytetrafluoroethylene, a polyphenylenesulfide, a polyamideimide, a polyetherimide, a polyethersulfone, a polyamide, a polyacetal, a polyphenyleneoxide, a polybutylenetelephthalate, an ethylene-propylene-diene terpolymer (EPDM), a sulfonated EPDM, a styrene butadiene rubber (SBR), a fluoride rubber, and various copolymers.

The composite anode may further include the conductive material to further improve electrical conductivity by providing a conductive passage to the above-described anode active material. The conductive material may be any conductive material that is commonly used in lithium batteries. Examples of the conductive material are: a carbonaceous material such as a carbon black, an acetylene black, a carbon black sold under the trade designation KETJENBLACK, and a carbon fiber (for example, a vapor phase growth carbon fiber); a metallic material such as copper, nickel, aluminum, and silver, each of which may be used in powder or fiber form; a conductive polymer such as a polyphenylene derivative; and any mixture thereof.

Examples of the solvent may include N-methylpyrrolidone (NMP), acetone, and water. The amount of the solvent may be in the range of about 1 part by weight to about 10 parts by weight based on 100 parts by weight of the anode active material. When the amount of the solvent is within the range above, the active material layer may be easily performed.

In addition, the current collector generally has a thickness of about 3 μm to about 500 The composition of the current collector is not particularly limited, and may be any material so long as it has a suitable conductivity without causing chemical changes in the manufactured battery. Examples of the current collector include copper, a stainless steel, aluminum, nickel, titanium, a sintered carbon, copper or a stainless steel surface-treated with carbon, nickel, titanium or silver, and one or more aluminum-cadmium alloys. In addition, the current collector may be processed to have fine irregularities on the surface thereof so as to enhance adhesive strength of the current collector to the anode active material, and may be used in any of various forms including films, sheets, foils, nets, porous structures, foams, and non-woven fabrics.

The prepared anode active material composition may be directly coated on the current collector to prepare the composite anode. Alternatively, the anode active material composition may be cast on a separate support and an anode active material film detached from the support may be laminated on a copper current collector to prepare the composite anode. The shape of the composite anode is not limited to those listed above, and any other shapes may be used.

The anode active material composition is used not only in the preparation of electrodes of lithium batteries, but also in the preparation of printable batteries by being printed on a flexible electrode plate.

Next, a cathode is prepared. For example, a cathode active material, a conductive material, a binder, and a solvent are mixed to prepare a cathode active material composition. The cathode active material composition is directly coated on a metal current collector to prepare a cathode. Alternatively, the cathode active material composition is cast on a separate support and a film detached from the support is laminated to prepare a cathode. The shape of the cathode is not limited to those listed above, and any other shapes may be used.

The cathode active material may be any lithium-containing metal oxide commonly used in the art without limitation. For example, at least one composite oxide of lithium and a metal selected from cobalt, manganese, nickel, and any combination thereof may be used. For example, the lithium-containing metal oxide may be one of the compounds represented by the following formulae: LiₐA_{1-b}B¹_{b}D¹₂ (where 0.90≤a≤1.8 and 0≤b≤0.5); LiₐE_{1-b}B¹_{b}O_{2-c}D¹_{c} (where 0.90≤a≤1.8, 0≤b≤0.5, and 0≤c≤0.05); LiE_{2-b}B¹_{b}O_{4-c}D¹_{c} (where 0≤b≤0.5 and 0≤c≤0.05); LiₐNi_{1-b-c}Co_{b}B¹_{c}D¹_{α} (where 0.90≤a≤1.8, 0≤b≤0.5, 0≤c≤0.05, and 0≤α≤2); LiₐNi_{1-b-c}Co_{b}B¹_{c}O_{2-α}F¹ₐ (where 0.90≤a≤1.8, 0≤b≤0.5, 0≤c≤0.05, and 0≤a≤2); LiₐNi_{1-b-c}Co_{b}B¹_{c}O_{2-α}F¹_{α} (where 0.90≤a≤1.8, 0≤b≤0.5, 0≤c≤0.05, and 0≤α≤2); LiₐNi_{1-b-c}Mn_{b}B¹_{c}D¹_{α} (where 0.90≤a≤1.8, 0≤b≤0.5, 0≤c≤0.05, and 0≤α≤2); LiₐNi_{1-b-c}Mn_{b}B¹_{c}O_{2-α}F¹_{α} (where 0.90≤a≤1.8, 0≤b≤0.5, 0≤c≤0.05, and 0≤α≤2); LiₐNi_{1-b-c}Mn_{b}B¹_{c}O_{2-α}F¹_{α} (where 0.90≤a≤1.8, 0≤b≤0.5, 0≤c≤0.05, and 0≤α≤2); LiₐNi_{b}E_{c}G_{d}O₂ (where 0.90≤a≤1.8, 0≤b≤0.9, 0≤c≤0.5, and 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, and 0.001≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMnG_{b}O₂ (where 0.90≤a≤1.8 and 0.001≤b≤0.1); LiₐMn₂G_{b}O₄ (where 0.90≤a≤1.8 and 0.001≤b≤0.1); QO₂; QS₂; LiQS₂; V₂O₅; LiV₂O₅; LiI¹O₂; LiNiVO₄; Li_{(3-f)} J₂(PO₄)₃ (where 0≤f≤2); Li_{(3-f)}Fe₂(PO₄)₃ (where 0≤f≤2); and LiFePO₄.

In the formulae representing the above-described compounds, A is Ni, Co, Mn, or any combination thereof; B¹ is Al, Ni, Co, Mn, Cr, Fe, Mg, Sr, V, a rare earth element, or any combination thereof; B¹ is O, F, S, P, or any combination thereof; E is Co, Mn, or any combination thereof; F¹ is F, S, P, or any combination thereof; G is Al, Cr, Mn, Fe, Mg, La, Ce, Sr, V, or any combination thereof; Q is Ti, Mo, Mn, or any combination thereof; I¹ is Cr, V, Fe, Sc, Y, or any combination thereof; and J is V, Cr, Mn, Co, Ni, Cu, or any combination thereof. For example, LiCoO₂, LiMnₓO₂ₓ (where x=1 or 2), LiNi₁₋ₓMnₓO₂ₓ (where 0<x<1), LiNi_{1-x-y}CoₓMn_{y}O₂ (where 0≤x≤0.5 and 0≤y≤0.5), and LiFePO₄ may be used.

The above-described compound having a coating layer formed on the surface thereof, or a mixture of the above-described compound and a compound having a coating layer may be used. The coating layer added to the surface of the above-described compound may include a compound of a coating element such as an oxide, a hydroxide, an oxyhydroxide, an oxycarbonate, or a hydroxycarbonate of the coating element. The compound constituting the coating layer may be amorphous or crystalline. The coating element included in the coating layer may be Mg, Al, Co, K, Na, Ca, Si, Ti, V, Sn, Ge, Ga, B, As, Zr, or any mixture thereof. The coating layer may be formed by using any method which does not adversely affect physical properties of the cathode active material (e.g., spray coating and immersing). Because the coating method is well known in the art, detailed descriptions thereof will be omitted.

The conductive material may be, but is not limited to, a carbon black, graphite particulates, or the like, and any material commonly used in the art as a conductive material may also be used. The binder may be, but is not limited thereto, a vinylidene fluoride/hexafluoropropylene copolymer, a polyvinylidene fluoride (PVDF), a polyacrylonitrile, polymethylmethacrylate, a polytetrafluoroethylene and any mixture thereof, a styrene butadiene rubber polymer, or the like, and any material commonly used in the art as a binder may also be used. The solvent may be, but is not limited to, N-methylpyrrolidone, acetone, water, or the like, and any material commonly used in the art as a solvent may also be used.

Amounts of the cathode active material, the conductive material, and the solvent may be the same level as those commonly used in lithium batteries. At least one of the conductive material, the binder, and the solvent may be omitted according to the use and the configuration of the lithium battery.

Next, a separator to be interposed between the cathode and the anode is prepared. The separator may be any separator commonly used in lithium batteries. Any separator having low resistance against migration of ions in the electrolyte and excellent electrolyte-retaining ability may be used. Examples of the separator may include a glass fiber, a polyester, a fluorine-containing polymer sold under the trade designation TEFLON® sold by E. I. Du Pont De Nemours and Company Corporation of Wilmington, Del., a polyethylene, a polypropylene, a polytetrafluoroethylene (PTFE), and any combination thereof, each of which may be a non-woven or a woven fabric form. For example, a windable separator including a polyethylene or a polypropylene may be used in a lithium-ion battery. A separator with excellent organic electrolyte retaining capability may be used in a lithium-ion polymer battery. For example, the separator may be manufactured in the following manner.

A polymer resin, a filler, and a solvent are mixed to prepare a separator composition. Next, the separator composition may be directly coated on an electrode, and then dried to form a separator. Alternatively, the separator composition may be cast on a support and then dried to form a separator film, and the separator film may be detached from the support and laminated on an electrode to form the separator.

The polymer resin used to manufacture the separator is not particularly limited and may be any material that is commonly used as a binder in electrode. Examples of the polymer resin include a vinylidenefluoride/hexafluoropropylene copolymer, a polyvinylidene fluoride (PVDF), a polyacrylonitrile, a polymethylmethacrylate, and any mixture thereof.

Subsequently, an electrolyte is prepared. For example, the electrolyte may be an organic electrolytic solution. Also, the electrolyte may be a solid. For example, the solid electrolyte may be a boron oxide, a lithium oxynitride, or the like. However, the solid electrolyte is not limited thereto and any known solid electrolyte may be used. The solid electrolyte may be formed on the anode by sputtering, or the like.

For example, the organic electrolytic solution may be prepared by dissolving a lithium salt in an organic solvent. The organic solvent may be any solvent available as an organic solvent in the art. Examples of the organic solvent may include a propylene carbonate, an ethylene carbonate, a fluoroethylene carbonate, a butylene carbonate, a dimethyl carbonate, a diethyl carbonate, a methylethyl carbonate, a methylpropyl carbonate, an ethylpropyl carbonate, a methylisopropyl carbonate, a dipropyl carbonate, a dibutyl carbonate, a benzonitrile, an acetonitrile, a tetrahydrofuran, a 2-methyltetrahydrofuran, a γ-butyrolactone, a dioxorane, a 4-methyldioxorane, a N,N-dimethyl formamide, a dimethyl acetamide, a dimethylsulfoxide, dioxane, a 1,2-dimethoxyethane, a sulforane, a dichloroethane, a chlorobenzene, a nitrobenzene, a diethylene glycol, a dimethyl ether, or a mixture thereof.

The lithium salt may be any lithium salt commonly used in the art. Examples of the lithium salt may include LiPF₆, LiBF₄, LiSbF₆, LiAsF₆, LiClO₄, LiCF₃SO₃, Li(CF₃SO₂)₂N, LiC₄F₉SO₃, LiAlO₂, LiAlCl₄, LiN(CₓF₂ₓ₊₁SO₂)(C_{y}F_{2y+1}SO₂) (where x and y are natural numbers), LiCl, LiI, or any mixture thereof.

FIG. 7 is a perspective, cut-away diagram illustrating an exemplary embodiment of a structure of a lithium secondary battery constructed according to principles of the invention.

As shown in FIG. 7, a lithium battery 121 includes a cathode 123, an anode 122, and a separator 124. The cathode 123, the anode 122, and the separator 124 may be wound or folded, and then accommodated in a battery case 125. Next, an organic electrolytic solution is injected into the battery case 125 and the battery case 125 is sealed with a cap assembly 126, thereby completing the manufacture of the lithium battery 121. The battery case 125 may have a generally cylindrical shape, a generally rectangular shape, or a generally thin-film shape. For example, the lithium battery 121 may be a generally thin-film battery. The lithium battery 121 may be a lithium ion battery.

The separator 124 is interposed between the cathode 123 and the anode 122 to form a battery assembly. When the battery assembly is stacked in a bi-cell structure and impregnated with an organic electrolytic solution, and the resultant is put into a pouch and sealed, preparation of a lithium-ion polymer battery is completed.

In addition, a plurality of battery assemblies may be stacked to form a battery pack, which may be used in any device that requires high capacity and high output, for example, in laptop computers, smart phones, and electric vehicles.

In addition, the lithium secondary battery may be used in electric vehicles (EVs) due to excellent lifespan characteristics and high-rate characteristics. For example, the lithium secondary battery may be used in hybrid vehicles such as plug-in hybrid electric vehicles (PHEVs). In addition, the lithium secondary battery may be used in the fields requiring a large amount of power storage. For example, the lithium secondary battery may be used in E-bikes and electric tools.

Hereinafter, one or more example embodiments will be described in more detail with reference to the following preparation examples, examples, and comparative examples.

However, these examples are not intended to limit the purpose and scope of the one or more exemplary embodiments.

### Preparation Example 1

Preparation of Silicon-carbonaceous Compound Composite

After adding 57 parts by weight of a silicon-containing composite to a planetary mixer, 32 parts by weight of coal tar pitch and 12 parts by weight of N-methylpyrrolidone as an additive were added thereto, followed by mixing for infiltration of the coal tar pitch into pores of the silicon-containing composite. The planetary mixer is a revolution and rotation type centrifugal mixer without a structure such as a rotor or a ball. A mixing process for infiltration of the coal tar pitch was performed in the order of agitating, degassing, and agitating, each for 5 minutes, for 15 minutes in total. This cycle is repeated four times in total. The agitating was performed at a revolution speed of 1000 revolutions per minute (rpm) and a rotation speed of 1000 rpm, the degassing was performed at a revolution speed of 2000 rpm and a rotation speed of 64 rpm, and 32 parts by weight of the coal tar pitch was divided into four portions and added to each cycle. The temperature was adjusted to about 70° C.

Subsequently, the resultant was heat-treated under a nitrogen gas atmosphere at about 1,000° C. for 3 hours.

Thus, a silicon-carbonaceous compound composite having a structure in which the carbonaceous coating layer including the first amorphous carbon is formed on the silicon-carbonaceous compound composite and the second amorphous carbon is included inside the silicon-containing composite was prepared. A mixing weight ratio of the first amorphous carbon to the second amorphous carbon was 1:2.

In the silicon-carbonaceous compound composite, a weight ratio of the carbon of the graphene flake to the carbon of the carbonaceous coating layer was 2:8. The graphene flake refers to both the first graphene flake and the second graphene flake.

An anode active material slurry was prepared by mixing 14.7 wt % of the silicon-carbonaceous compound composite, 80.3 wt % of artificial graphite, 5 wt % of SFG6 graphite (D₅₀=6 μm) as a conductive material, 1.2 wt % of styrene-butadiene rubber (SBR), and 1 wt % of carboxymethyl cellulose (CMC) based on a total weight of the silicon-carbonaceous compound composite, the artificial graphite, and the conductive material, and the slurry was coated on a copper foil to a thickness of 80 pressed, and dried to prepare an anode.

### Preparation Example 2

An anode was prepared in the same manner as in Preparation Example 1, except that 14.7 wt % of the silicon-carbonaceous compound composite, 77.8 wt % of the artificial graphite, and 7.5 wt % of the SFG6 graphite as the conductive material were mixed.

### Preparation Example 3

An anode was prepared in the same manner as in Preparation Example 1, except that 14.7 wt % of the silicon-carbonaceous compound composite, 75.3 wt % of the artificial graphite, and 10 wt % of the SFG6 graphite as the conductive material were mixed.

### Preparation Example 4

Crystalline carbon (graphite, graphene nanosheets (GNs), and soft carbon), nano-silicon (D50: 100 nm) pulverized for 10 to 20 hours using a beads mill (manufactured by NETZSCH-Feinmahltechnik GmbH of Selb, Germany), and an amorphous carbon (pitch, resin, hydrocarbon, or the like) were mixed in a solvent (isopropyl alcohol (IPA), ethanol (ETOH), or the like) in a weight ratio of 40:40:20 and uniformly dispersed using a homogenizer. Subsequently, the dispersion was sprayed and dried by using a spray dryer at a temperature of 50° C. to 100° C. and heat-treated using a furnace in a nitrogen atmosphere at a temperature of 900° C. to 1000° C. to perform coating with amorphous carbon. Next, pulverization and sieving with a 400-mesh sieve were performed to finally obtain a silicon-carbonaceous compound composite having an amorphous carbon coating layer.

An anode active material slurry was prepared by mixing 18 wt % of the silicon-carbonaceous compound composite in which silicon particles having an average particle diameter of about 150 nm are present on and in graphite, 77 wt % of artificial graphite, 5 wt % of SFG6 graphite as a conductive material, 1.2 wt % of SBR, and 1 wt % of CMC based on a total weight of the silicon-carbonaceous compound composite, the artificial graphite, and the conductive material, and the slurry was coated on a copper foil to a thickness of 80 pressed, and dried to prepare an anode.

### Preparation Example 5

An anode active material slurry was prepared by mixing 18 wt % of the silicon-carbonaceous compound composite according to Preparation Example 4, 74.5 wt % of artificial graphite, 7.5 wt % of SFG6 graphite as a conductive material, and 1.2 wt % of SBR, and the slurry was coated on a copper foil to a thickness of 80 pressed, and dried to prepare an anode.

### Preparation Example 6

An anode active material slurry was prepared by mixing 18 wt % of the silicon-carbonaceous compound composite according to Preparation Example 4, 72 wt % of artificial graphite, 10 wt % of SFG6 graphite as a conductive material, and 1.2 wt % of SBR, and the slurry was coated on a copper foil to a thickness of 80 pressed, and dried to prepare an anode.

### Comparative Preparation Example 1

An anode was prepared in the same manner as in Preparation Example 1, except that 14.7 wt % of the silicon-carbonaceous compound composite and 85.3 wt % of artificial graphite were mixed.

### Comparative Preparation Example 2

An anode was prepared in the same manner as in Preparation Example 1, except that 14.7 wt % of the silicon-carbonaceous compound composite, 72.88 wt % of artificial graphite, and 12.5 wt % of SFG6 graphite as a conductive material were mixed.

### Comparative Preparation Example 3

An anode was prepared in the same manner as in Preparation Example 1, except that 14.7 wt % of the silicon-carbonaceous compound composite, 70.3 wt % of artificial graphite, and 15 wt % of SFG6 graphite as a conductive material were mixed.

### Evaluation Example 1 (Evaluation of Electrode Conductivity)

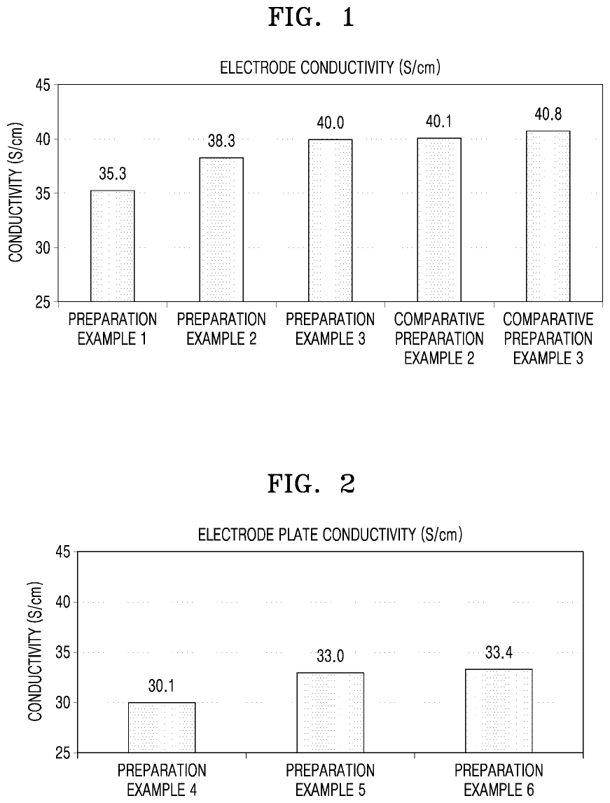

FIG. 1 is a graphical depiction illustrating electrode conductivity of exemplary embodiments of composite anodes prepared in Preparation Examples 1 to 3 according to principles of the invention and Comparative Preparation Examples 2 and 3. FIG. 2 is a graphical depiction illustrating electrode conductivity of exemplary embodiments of composite anodes prepared in Preparation Examples 4 to 6 according to principles of the invention.

Referring to FIGS. 1 and 2, when a mixture of a certain silicon-carbonaceous compound composite and a predetermined amount of the conductive material was used as in the composite anodes prepared in Preparation Examples 1 to 6, conductivity was not considerably decreased when compared with the case in which the amount of the conductive material was increased.

For reference, although the composite anodes prepared in Preparation Examples 4 to 6 include the same or more amounts or types of the conductive material, conductivities thereof were not higher than the composite anodes prepared in Preparation Examples 1 to 3.

### Example 1

Preparation of Half Cell

A half cell was prepared using the composite anode according to Preparation Example 1 as a working electrode, using a lithium metal as a counter electrode, locating a separator between the working electrode and the counter electrode, and injecting a liquid electrolyte thereinto.

### Example 2

A half cell was prepared in the same manner as in Example 1, except that the composite anode according to Preparation Example 2 was used as a working electrode.

### Example 3

A half cell was prepared in the same manner as in Example 1, except that the composite anode according to Preparation Example 3 was used as a working electrode.

### Example 4

A half cell was prepared in the same manner as in Example 1, except that the composite anode according to Preparation Example 4 was used as a working electrode.

### Example 5

A half cell was prepared in the same manner as in Example 1, except that the composite anode according to Preparation Example 5 was used as a working electrode.

### Example 6

A half cell was prepared in the same manner as in Example 1, except that the composite anode according to Preparation Example 6 was used as a working electrode.

### Comparative Example 1

A half cell was prepared in the same manner as in Example 1, except that the composite anode according to Comparative Preparation Example 1 was used as a working electrode.

### Comparative Example 2

A half cell was prepared in the same manner as in Example 1, except that the composite anode according to Comparative Preparation Example 2 was used as a working electrode.

### Comparative Example 3

A half cell was prepared in the same manner as in Example 1, except that the composite anode according to Comparative Preparation Example 3 was used as a working electrode.

### Comparative Example 4

A half cell was prepared in the same manner as in Example 1, except that SFG6 graphite having a D₅₀ particle diameter of 15 μm was used instead of the SFG6 graphite having a D₅₀ particle diameter of 6 μm.

### Evaluation Example 2 (Evaluation of Rate Characteristics)

The half cells prepared in Examples 1 to 3 and Comparative Examples 1 to 3 were charged at a constant current of 0.7 C rate at 25° C. until a voltage reached 4.47 V (vs. Li), and the charging process was cut off at a current of 0.025 C rate in a constant voltage mode while maintaining the voltage of 4.47 V. Subsequently, the half cells were discharged at a constant current of 0.2 C rate until the voltage reached 3 V (vs. Li), thereby completing a formation process.

The lithium batteries that underwent the formation process were charged at a constant current of 0.7 C rate at 25° C. until the voltage reached 4.47 V (vs. Li), and the charging process was cut off at a current of 0.025 C rate in a constant voltage mode while maintaining the voltage of 4.47 V. Next, the lithium batteries were discharged at a constant current of 1.0 C rate until the voltage reached 3 V (vs. Li).

The charge and discharge test results are shown in Table 1 below. Discharge rate characteristics and charge rate characteristics are defined by Equations 1 and 2 below, respectively.

Discharge rate characteristics [%]=[discharge rate at 2 C/discharge rate at 0.2 C]×100 Equation 1

Charge rate characteristics [%]=[charge rate at 2 C/charge rate at 0.2 C]×100 Equation 2

TABLE 1

| | | Discharge rate | Charge rate | |
|---|---|---|---|---|
| | Capacity | characteristics | characteristics | Efficiency |
| | (0.2 C) | (2 C/0.2 C) | (2 C/0.2 C) | (%) |
| Example 1 | 498 | 94.1 | 41.5 | 90.4 |
| Example 2 | 499 | 94.7 | 43.5 | 90.2 |
| Example 3 | 503 | 95.8 | 44.6 | 90.2 |
| Comparative | 497 | 92.3 | 41.5 | 90.4 |
| Example 1 | | | | |
| Comparative | 498 | 96.1 | 42.8 | 89.9 |
| Example 2 | | | | |
| Comparative | 500 | 95.3 | 41.3 | 89.9 |
| Example 3 | | | | |

Referring to the results in Table 1 confirm that the half cells including excess of conductive materials (Comparative Examples 2 and 3) have decrease efficiency compared to the half cell including a 10% increase in conductive material by 10% according to Example 3.

When the efficiency decreases below 90% as shown in Comparative Examples 2 and 3, it is difficult to use the lithium batteries.

### Evaluation Example 3 (Evaluation of Lifespan Characteristics)

1) The half cells prepared in Examples 1 to 3 and Comparative Examples 1 to 3 were charged at a constant current of 1.0 C rate at 25° C. until the voltage reached 4.0 V (vs. Li), and the charging process was cut off at a current of 0.05 C rate in a constant voltage mode while maintaining the voltage of 4.0 V. Next, the half cells were discharged at a constant current of 1.0 C rate until the voltage reached 2.5 V (vs. Li), thereby completing a formation process.

The lithium batteries that underwent the formation process were charged at a constant current of 1.0 C rate at 25° C. until the voltage reached 4.0 V (vs. Li), and the charging process was cut off at a current of 0.05 C rate in a constant voltage mode while maintaining the voltage of 4.0 V. Next, the lithium batteries were discharged at a constant current of 1.0 C rate until the voltage reached 2.5 V (vs. Li). This charging and discharging cycle was repeated 350 times.

The lithium batteries rested for 10 minutes after every charging and discharging cycle.

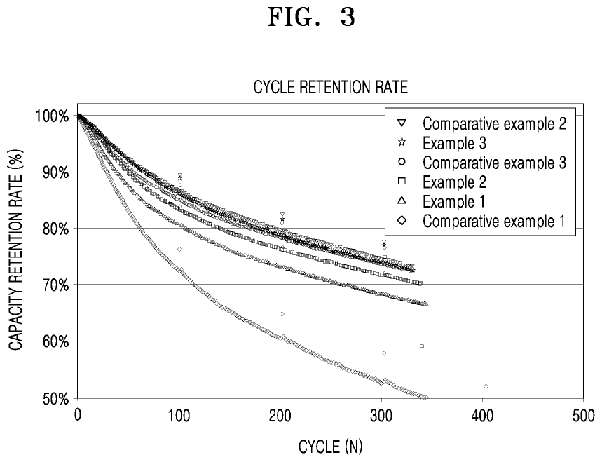

FIG. 3 is a graphical depiction illustrating cycle characteristics of exemplary embodiments of lithium secondary batteries prepared in Examples 1 to 3 according to principles of the invention and Comparative Examples 1 to 3. The charge and discharge test results are shown in FIG. 3. The capacity retention rate at the 350^{th} cycle is defined by Equation 3 below.

Capacity retention rate [%]=[discharge capacity at 350^{th} cycle/discharge capacity at 1^{st} cycle]×100 Equation 3

2) The half cells prepared in Examples 4 to 6 were charged at a constant current of 1.0 C rate at 25° C. until the voltage reached 4.0 V (vs. Li), and the charging process was cut off at a current of 0.05 C rate in a constant voltage mode while maintaining the voltage of 4.0 V. Next, the half cells were discharged at a constant current of 1.0 C rate until the voltage reached 2.5 V (vs. Li), thereby completing the formation process.

The lithium batteries that underwent the formation process were charged at a constant current of 1.0 C rate at 25° C. until the voltage reached 4.0 V (vs. Li), and the charging process was cut off at a current of 0.05 C rate in a constant voltage mode while maintaining the voltage of 4.0 V. Next, the lithium batteries were discharged at a constant current of 1.0 C rate until the voltage reached 2.5 V (vs. Li). This charging and discharging cycle was repeated 250 times.

The lithium batteries rested for 10 minutes after every charging and discharging cycle.

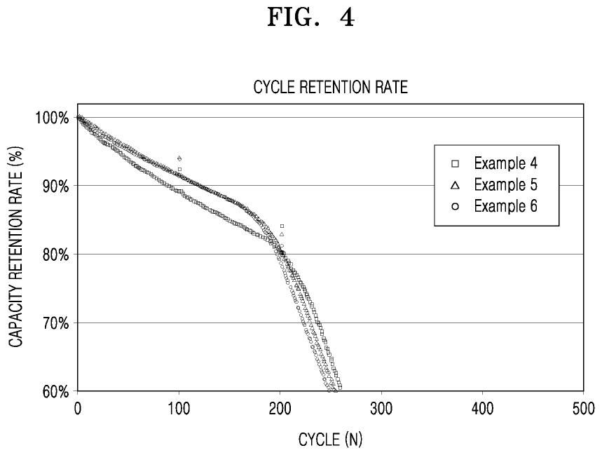

FIG. 4 is a graphical depiction illustrating cycle characteristics of exemplary embodiments of lithium secondary batteries prepared in Examples 4 to 6 according to principles of the invention. The charge and discharge test results are shown in FIG. 4.

The slopes according to the examples of exemplary embodiments and the comparative examples shown in FIGS. 3 and 4 confirm that the increase in capacity retention rates of the lithium batteries made according to the examples is excellent, and while the improvement in the capacity retention rates of the lithium batteries made according to the comparative examples is negligible. Particularly, in the comparative examples, when the amount of the conductive material increases, an increase in capacity retention rates is not observed. Referring to the results shown in Table 1, efficiency and processibility decrease.

### Evaluation Example 4

Rate characteristics and capacity characteristics of the lithium batteries according to Example 1 and Comparative Example 4 were compared and the results are shown in Table 2 below.

Methods of evaluating the rate characteristics and capacity characteristics are as described below:

1) Formation charging: 0.1 C/0.01 V, 0.01 C

2) Formation discharging: 0.1 C/1.5 V

3) Formation efficiency: formation discharging/formation charging×100

4) Standard discharging: 0.2 C/1.5 V

5) Single conversion capacity of porous silicon cluster composite:

Single conversion capacity of porous silicon cluster composite=((capacity of final blending−(graphite capacity×graphite blending ratio))/blending ratio of porous silicon cluster composite

6) Charging rate characteristics: 2 C charge capacity (CC section)/0.2 C charge capacity (CC section)

TABLE 2

| | | Comparative |
|---|---|---|
| | Example 1 | Example 4 |
| Formation | 521 | 499 |
| charging (mAh/g) | | |
| Formation | 474 | 454 |
| discharging (mAh/g) | | |
| Formation | 91.1% | 91.1% |
| efficiency (%) | | |
| Standard | 472 | 451 |
| discharging (mAh/g) | | |
| Single conversion | 1249 | 1226 |
| capacity of | | |
| porous silicon | | |
| cluster composite | | |
| Charging rate | 22 | 20 |
| characteristics | | |
| (2 C/0.2 C) | | |

The results in Table 2 above confirm that, when the average particle diameter (D₅₀) of the conductive material is excessively large as in Comparative Example 4, conductivity deteriorates and rate characteristics and capacity characteristics deteriorate when compared with Example 1.

Including the composite anode including the silicon-carbonaceous compound composite, the graphite, and the generally plate-shaped conductive material in predetermined compositions according the principles and exemplary implementations of the invention significant and surprising improvement in cycle characteristics and conductivity of lithium secondary batteries are obtained.

Although certain exemplary embodiments and implementations have been described herein, other embodiments and modifications will be apparent from this description. Accordingly, the inventive concepts are not limited to such embodiments, but rather to the broader scope of the appended claims and various obvious modifications and equivalent arrangements as would be apparent to a person of ordinary skill in the art.

What is claimed is:

1. A composite anode for a lithium secondary battery, the composite anode comprising:
a silicon-carbonaceous compound composite;
a graphite; and
a generally plate-shaped conductive material.

2. The composite anode of claim 1, wherein the silicon-carbonaceous compound composite comprises silicon particles coated with a carbonaceous compound.

3. The composite anode of claim 1, wherein the silicon-carbonaceous compound composite comprising a porous silicon composite cluster having a porous core including a porous silicon composite secondary particle and a shell including a second graphene formed on the core.

4. The composite anode of claim 1, wherein the silicon-carbonaceous compound composite comprises a silicon-containing composite including a porous silicon secondary particle; and a carbonaceous coating layer including a first amorphous carbon formed on the silicon-containing composite,
wherein the silicon-containing composite comprises a second amorphous carbon to adjust a density of the silicon-containing composite substantially identical to or lower than a density of the carbonaceous coating layer,
the porous silicon secondary particle comprises an aggregate of at least two silicon composite primary particles,
the silicon composite primary particle comprises:
a silicon,
a silicon suboxide of the formula of SiOₓ, where 0<x<2, on at least one surface of the silicon; and
a first carbon flake on at least one surface of the silicon suboxide, and
a second carbon flake is disposed on at least one surface of the porous silicon secondary particle.

5. The composite anode of claim 1, wherein the silicon-carbonaceous compound composite comprises:
a crystalline carbon;
an amorphous carbon; and
silicon nanoparticles having a generally acicular shape, a generally scaly shape, a generally plate-shape, or any combination thereof.

6. The composite anode of claim 5, wherein the composite anode has a core-shell structure comprising:
a core including the silicon-carbonaceous compound composite; and
a shell including a carbon coating layer surrounding the surface of the core.

7. The composite anode of claim 1, wherein the graphite comprises artificial graphite, natural graphite, or any mixture thereof.

8. The composite anode of claim 1, wherein a weight ratio of the silicon-carbonaceous compound composite to the graphite is about 15:85 to about 20:80.

9. The composite anode of claim 1, wherein an amount of the generally plate-shaped conductive material is about 5 wt % to about 10 wt % based on a total weight of the composite anode.

10. The composite anode of claim 1, wherein the generally plate-shaped conductive material has an average particle diameter (D₅₀) of about 3 μm to about 7 μm.

11. The composite anode of claim 1, wherein the generally plate-shaped conductive material has a specific surface area of a BET value of about 13.5 m²/g to about 17.5 m²/g.

12. The composite anode of claim 1, wherein the generally plate-shaped conductive material has a pellet density of about 1.7 g/cc to about 2.1 g/cc.

13. The composite anode of claim 1, wherein the generally plate-shaped conductive material comprises a SFG6 graphite, a generally scaly graphite, a graphene, a graphene oxide, a carbon nanotube, or a mixture thereof.

14. The composite anode of claim 1, wherein the composite anode comprises a silicon in an amount of about 5.5 wt % to about 9.5 wt % based on a total weight of the composite anode.

15. The composite anode of claim 1, wherein the silicon-carbonaceous compound composite, the graphite, and the generally plate-shaped conductive material has a mixture density of about 1.5 g/cc or more.

16. The composite anode of claim 1, wherein the silicon-carbonaceous compound composite, the graphite, and the generally plate-shaped conductive material have a composition ratio based on 100 parts by weight of the composite anode comprising:
about 14.7 parts by weight to about 19.7 parts by weight of the silicon-carbonaceous compound composite;
about 75.3 parts by weight to about 80.3 parts by weight of the graphite; and
about 5 to about 10 parts by weight of the generally plate-shaped conductive material.

17. A lithium secondary battery comprising:
a cathode;
the composite anode according to claim 1; and
an electrolyte.
